(19) United States
(12) Patent Application Publication
(10) Pub. No.: US 2020/0399987 A1
(43) Pub. Date: Dec. 24, 2020

(54) System and Method for Predicting Fluid Behavior in an Unconventional Shale Play

(71) Applicant: Shale Value, LLC, Katy, TX (US)

(72) Inventor: Ashish Dabral, Katy, TX (US)

(21) Appl. No.: 16/447,038

(22) Filed: Jun. 20, 2019

(51) Int. Cl. E21B 41/00; G06N 20/00; G06F 17/50

(52) U.S. Cl. CPC E21B 41/0092; E21B 41/0035; G06F 17/5009; G06N 20/00

(57) ABSTRACT

A system and method for generating a PVT model capable of predicting well behavior across a play is described. The method can comprise the step of obtaining, for each well of a subset of wells, a measured API gravity, a measured gas-to-oil ratio (GOR), and one or more lab experiments. The lab experiments can measure one or more PVT characteristics. The method can also comprise the step of training a PVT model to match the measured API gravities and the measured GOR with the PVT characteristics. Further, the method can comprise the step of inputting a PVT input into the PVT model and receiving a PVT output from the PVT model. The PVT input can be related to an additional hydrocarbon sample. The PVT input can comprise an API gravity and a GOR. The PVT output can be based on the API gravity and the GOR.

### BACKGROUND

This disclosure relates to an improved system and method for predicting fluid behavior in a self-sourced unconventional shale gas and tight oil play.

Shale gas and tight oil development involves horizontal drilling and hydraulic fracturing to produce commercially from these tight formations. Conventional reservoirs, such as the reservoirs that have been commercially developed over the last century, are rock systems which store hydrocarbon fluid that has migrated away from the rock system where they were generated. This fluid was generated in a source rock and then migrated to the conventional reservoir where the hydrocarbons are stored in the sub-surface. These conventional reservoirs are very permeable and as such, the hydrocarbons flow with no or minimal stimulation. For this reason, these reservoirs can be produced using traditional drilling and completion methods. By comparison, in unconventional reservoirs such as shale gas reservoirs and tight oil reservoirs, the rock system where the hydrocarbons are stored in the same rock system in which they were generated. Such shale formations are of low permeability. Also, unconventional reservoirs usually extend over a very large area compared to conventional reservoirs. Across this area, the reservoir can have varying types of hydrocarbon fluids and reservoir rock properties.

According to the Energy Information Administration, the US produced 6.5 million barrels per day of tight oil and sixty-five billion cubic feet of natural gas in 2018 from shale gas and tight oil reservoirs, and oil production is expected to grow to ten-million barrels/day by the early 2030s. However, future growth of domestic tight oil and shale gas production depends on a variety of factors, including the quality of resources, technology and operational improvements that increase productivity.

Over the past couple of decades, much of shale oil technology has centered around improving hydraulic fracturing, surface operational efficiencies and reducing costs. Examples of industry has significant strides include rig move optimization and high intensity hydraulic fracturing. The industry is now focusing on better understanding of the subsurface. The industry's focus on better understanding the subsurface accelerated after the 2014 commodity price drop which provided an impetus to further optimize operations. The reservoir is a rock-fluid system. Consequentially, over the last decade the industry has focused almost entirely on the rock and well fracturing, and the industry is just beginning to gain a better understanding of the reservoir fluid behavior. With operators experimenting with enhanced oil recovery (EOR) in unconventional reservoirs, fluid pressure, volume and temperature (PVT) behavior is going to be further in focus. Fluid PVT behavior in self-sourced systems is considerably different from that in conventional migratory systems. Better understanding of this behavior will be vital as the industry seeks the next set of technologies to deliver step changes in well productivity improvements.

The industry also looks at pressure, volume and temperature (PVT) characteristics of existing wells of a shale play to better understand the shale play. By understanding PVT characteristics of a given hydrocarbon mixture, behavior of that mixture can also be defined. Crude oil, condensate and natural gas that are found in both conventional and shale gas/tight oil reservoirs are complex mixtures of hydrocarbons. Defining the behavior of a given hydrocarbon mixture at various pressures and temperatures is necessary because the hydrocarbon mixture when extracted from the sub-surface reservoir goes through various pressures and temperatures and goes through changes in behavior of storage and flow. PVT characteristics are required to compute the quantity of hydrocarbons stored in the reservoir, the volume of hydrocarbons that can be extracted, and the number of wells that are required to be drilled in order to optimize recover and maximize profit of a given project. PVT characteristics are also necessary to design surface facilities to maximize the value of a produced well stream, forecast the oil and gas production through the life of a well, project or field, and conduct numerical simulations on reservoir engineering calculations

However, since there is significant variation in hydrocarbon fluids across a reservoir, multiple samples of these fluids need to be collected and analyzed in a lab to properly describe the behavior of the fluid system across the entire reservoir. Depending on the variability across the reservoir, some regions in a reservoir may require more fluid samples than others. Also, in areas such as the Delaware Basin in the Permian region, there are several vertically-stacked producing formations. In some areas, operators have announced that there are as many eight vertically-stacked productive formations. Therefore, considering areal variations across each productive formation, a large number of samples could be required to characterize the fluids across each of these formations across an operator's acreage.

Unfortunately, PVT data is not often as prolific as one analyzing such data may hope, for a number of reasons. First, many E&P operators simply do not collect as much data as they might like simply because of associated costs. On average PVT lab measurements are only captured on one to two percent of wells drilled. A driver of this trend is that typical costs for analyzing a single sample are between $30,000 and $50,000, depending on testing performed. Second, many E&P operators don't collect much data because they don't have the PVT engineering personnel necessary to exploit the data after its capture. Mid-size-to-large operators typically collect 10-25 samples from across their acreage in a play. Smaller operators often collect few samples to none. Given the variations in fluid and reservoir properties across an operator's acreage, the number of samples analyzed are not sufficient. Third, even if an E&P operator were to collect PVT data from many wells there would still be geographical gaps within the sampling for two reasons. First acreage owned by E&P operators is often spread across a wide area and well dispersion is not homogenous. Second, the area is rarely contiguous.

Under-sampling leads to poor understanding of the reservoir fluids leading to economically sub-optimal recovery, with project economics being adversely affected by as much as twenty-percent, poor drawdown management leading to reduced recovery of oil/condensate, and high error margins in reported reserves and production forecasts. Such PVT related deviations from forecasts have significantly impacted valuations and share price of public companies in the past.

For these reasons, reliable models are needed within the shale gas industry that can provide accurate information with minimal and easily available data inputs. One notable existing model attempts to do just that. Specifically, the model correlates gas condensates and wet gases in an unconventional gas play using an equation of state that takes into consideration a condensate gas ratio, a separator temperature, and a separator pressure. However, the existing model has a number of issues. First, separator temperature and separator pressure are not available in the public domain, and therefore the analysis is limited to each operator since such data is proprietary and therefore cannot provide an understanding of the entire fluid system. Further, such model is limited to gas but cannot be used for oil. Even further, a hydrocarbon composition of all components is a function of both gas-oil-ratio (GOR) and API gravity. However, the present model does not take both into consideration together. The problem with such approach is that GOR and API gravity are both dependent on separator conditions. For a given well stream composition, different separator conditions result in various combinations of GOR and API gravity. For example, higher separator temperature will result in higher GOR and a lower API gravity and vice versa. Therefore, in order to properly define the fluid, both API gravity and GOR together are required, but are not being considered by the present model. Lastly, an over-simplified model as what presently exists can lead to inaccuracies. First, in most shale and tight oil plays, fluid maturities vary significantly. For example, fluid properties can vary even across relatively small distances. Also, in areas of transition, fluid properties vary rapidly and the changes are abrupt. Second, a play can have multiple formations with varying fluid properties across each formation. For example, reservoir depths and other properties can vary from formation to formation. For these and other reasons, an overly-simplistic model can lead to significant errors. Errors are a problem because errors in fluid analysis can lead to poor well placement, which can significantly impact economics. Said another way, poor well placement can mean the difference between production from a shale play being economically feasible, less economically feasible, or even not economically feasible.

As such it would be useful to have an improved system and method for predicting fluid behavior in an unconventional shale play.

### SUMMARY

A method for generating a PVT model capable of predicting well behavior across a play is described herein. The method can comprise the step obtaining, relating to each well of a subset of wells, a measured API gravity, a measured gas-to-oil ratio (GOR), and one or more lab experiments. The lab experiments can measure one or more PVT characteristics. The method can also comprise the step of training a PVT model to match the measured API gravities and the measured GOR with the PVT characteristics. Further, the method can comprise the step of inputting a PVT input into the PVT model and receiving a PVT output from the PVT model. The PVT input can be related to an additional hydrocarbon sample. The PVT input can comprise an API gravity and a GOR. The PVT output can be based on the API gravity and the GOR.

In one embodiment, the PVT output can comprise a composition table. In another embodiment, the PVT output can comprise a black oil table. In another embodiment, the PVT output can comprise a molecular weight of oil. In another embodiment, the PVT output can comprise a molecular weight of oil condensate. In another embodiment, the PVT output can comprise a saturation pressure. The composition table, black oil table, molecular weight of oil, molecular weight of oil condensate, and the saturation pressure can each, in one embodiment, be calculated based on the API gravity and the GOR. In another embodiment, the method further comprises the step of determining a location of a well based at least in part by the PVT output.

A system for generating a PVT model capable of predicting well behavior across a play is also herein described. The system can comprise a memory and a processor. The memory can comprise an application and a data store. The processor, according to the application in the memory, can obtain, sets of information related to each well of a subset of wells. The information can include a measured API gravity, a measured gas-to-oil ratio (GOR), and one or more lab experiments. The lab experiments can be measuring one or more PVT characteristics. Moreover, the processor can train a PVT model to match the measured API gravities and the measured GOR with the PVT characteristics. The processor can also input a PVT input into the PVT model and can receive a PVT output from the PVT model. The PVT input can be related to an additional hydrocarbon sample and can comprise an API gravity and a GOR. The PVT output can be based on the API gravity and the GOR.

In one embodiment obtaining the measured API gravities, the measured GORs, and the one or more lab experiments can comprise obtaining sets of lab measurements from hydrocarbon samples from the subset of wells. Each of the set of lab measurements can comprise the measured API gravity, the measured GOR, and the one or more lab experiments. In another embodiment, the processor can also obtain, relating to each well of the subset of wells, a measured composition. In such embodiment, the PVT model can comprise a composition model, and the PVT output can comprise a composition table.

A method for generating a PVT model capable of predicting well behavior across a play is herein described. The method can comprise the step of obtaining sets of lab measurements from hydrocarbon samples of a subset of a plurality of wells. Each set of the sets can be associated with a subset well of the subset of the plurality of wells. The lab measurements can comprise a measured API gravity, a measured gas-to-oil (GOR) ratio, a measured composition, and one or more lab experiments. The method can also comprise the step of training a model using the lab measurements by tuning an equation of state, adjusting Peneloux correction factors, and creating a composition model. The equation of state can be tuned by dividing each of the measured compositions into component groupings, the groupings comprising variable attributes, and adjusting the variable attributes to match the one or more lab experiments. Peneloux correction factors can be adjusted such that the measured API gravities and the measured GORs of the lab measurements can match calculated API gravities and calculated GORs. The composition model created can be a function of a variable API gravity and a variable GOR. Further, the composition model, a composition model constituent of a PVT model such that when the PVT model receive a PVT input that can comprise an API gravity and a GOR, the PVT model can generate PVT output. The PVT output can comprise a composition table generated using the composition model.

In one embodiment, the method can further comprise the step of feeding initial PVT inputs from remaining wells of the plurality of wells into the model that has been trained to produce an initial PVT output for each of the initial PVT inputs. Each of the initial PVT inputs can comprise an initial API gravity and an initial GOR. Each of the initial PVT outputs can be calculated using the initial API gravity and the initial GOR.

In one such embodiment, each of the initial PVT outputs can comprise an initial saturation pressure (P_{SAT}) calculated using the initial API gravity and the initial GOR. Further, the initial P_{SAT}s can be curve-fitted to produce a P_{SAT} equation that can calculate a subsequent P_{SAT} as a function of the variable API gravity and the variable GOR. The P_{SAT} equation can be a P_{SAT} constituent of the PVT model.

In another embodiment, each of the initial PVT outputs can comprise an initial molecular weight of oil (MW_{O}) that can be calculated using the initial API gravity and the initial GOR. Further, the initial MW_{O}s can be curve-fitted to produce an MW_{O} equation that can calculate a subsequent MW_{O} as a function of the variable API gravity and the variable GOR. The MW_{O} equation can be an MW_{O} constituent of the PVT model.

In another embodiment, each of the initial PVT outputs can comprise an initial molecular weight of oil condensate (MW_{C}) that can be calculated using the initial API gravity and the initial GOR. Further, the initial MW_{C}s can be curve-fitted to produce an MW_{C} equation that can calculate a subsequent MW_{C} as a function of the variable API gravity and the variable GOR. The MW_{C} equation can be an MW_{C} constituent of the PVT model.

In another embodiment, each of the initial PVT outputs can comprise an initial black oil table that can be calculated using the initial API gravity and the initial GOR. Further, the initial black oil tables can be curve-fitted to produce a black oil table model that can calculate a subsequent black oil table as a function of the variable API gravity and the variable GOR. The black oil table model can be a black oil table constituent of the PVT model. In one such embodiment, the method can comprise the steps of determining remaining hydrocarbons for a site using the subsequent black oil table generated from a subsequent PVT input, and choosing a new well location of a new well based at least in part on the determination.

In another embodiment, each of the initial PVT outputs can comprise a characteristic line calculated using the initial API gravity and the initial GOR. In such embodiment, the method can further comprise the step of determining a saturation limit line based on the characteristic lines. Further, the method can comprise the step of plotting the saturation limit line on an API gravity-GOR graph. The saturation limit line can form at least a portion of a characteristic plot. The characteristic plot can be a characteristic plot constituent of the PVT model. In one embodiment, the method can further comprise the steps of feeding a subsequent PVT input that can be related to a new hydrocarbon sample into the PVT model, generating a subsequent characteristic point that can be related to the subsequent PVT input, and determining if the hydrocarbon sample is saturated if the subsequent characteristic point is below the saturation limit line.

In one embodiment, the method can further comprise the step of determining a sample validity limit line based on the characteristic lines. The method can further comprise the step of plotting the sample validity limit line on the API gravity-GOR graph. The sample validity limit line that can form at least a portion of a characteristic plot. The characteristic plot can be a characteristic plot constituent of the PVT model. In one embodiment, the method can further comprise the steps of feeding a subsequent PVT input that can be related to a new hydrocarbon sample into the PVT model, generating a subsequent characteristic point that can be related to the subsequent PVT input, and screening out the hydrocarbon sample if the subsequent characteristic point can be above the sample validity limit line.

A system for generating a PVT model capable of predicting well behavior across a play is also herein described. The system can comprise a memory and a processor. The memory can comprise an application and a data store. The processor, according to the application in the memory, can obtain sets of lab measurements from hydrocarbon samples of a subset of a plurality of wells, and train a model using the lab measurements. Each lab measurement set can be associated with a subset well. The lab measurements can comprise a measured API gravity, a measured gas-to-oil (GOR) ratio, a measured composition, and one or more lab experiments. Furthermore, the processor can train a model using the lab measurements by tuning an equation of state, adjusting Peneloux correction factors, and creating a composition model. The equation of state can be tuned by dividing each of the measured compositions into component groupings, the one or more groups of the component groupings comprising variable attributes, and adjusting the variable attributes to match the one or more lab experiments. Peneloux correction factors can be adjusted such that the measured API gravities and the measured GORs of the lab measurements can match calculated API gravities and calculated GORs. The composition model created can be a function of a variable API gravity and a variable GOR. Further, the composition model, a composition model constituent of a PVT model such that when the PVT model receive a PVT input that can comprise an API gravity and a GOR, the PVT model can generate PVT output. The PVT output can comprise a composition table generated using the composition model.

In one embodiment, the hydrocarbon sample can be an oil hydrocarbon sample. In another embodiment, the hydrocarbon sample can be a gas condensate hydrocarbon sample. Further, in the one or more lab experiments can comprise a constant composition expansion test, a constant volume depletion test, a differential liberator test, and/or a separator test.

In another embodiment, the processor can feed sets of initial PVT inputs from remaining wells of the plurality of wells into the model that has been trained to produce initial PVT outputs. In such embodiment, the processor can further curve-fit the initial PVT outputs to produce one or more functions of a variable API and a variable GOR. The one or more functions can be a constituent of the PVT model. In one embodiment, the one or more functions can comprise a P_{SAT} equation and the subsequent PVT output can comprise a subsequent P_{SAT}. In another embodiment, the one or more functions can comprise an MW_{O} equation and the subsequent PVT output can comprise a subsequent MW_{O}. Similarly, in another embodiment, the one or more functions can comprise an MW_{C} equation and the subsequent PVT output can comprise a subsequent MW_{C}. In yet another embodiment, the one or more functions can comprise a black oil table model and the subsequent PVT output can comprise a subsequent black oil table.

In another embodiment, the processor can determine a location of a well at least in part by feeding a subsequent PVT input into the PVT model and receiving a subsequent PVT output from the model. The subsequent PVT output can comprise a subsequent API gravity and a subsequent GOR. The determination can be based on the subsequent PVT output. In one embodiment, the PVT input can further comprise an N₂, H₂S, and/or CO₂.

A computer-readable storage medium is also disclosed. The computer-readable storage medium having a computer readable program code embodied therein, the computer readable program code can be adapted to be executed to implement the above-mentioned method.

A method for predicting well behavior within a play using information available in the public domain is also described herein. The method can comprise the steps of inputting into a PVT model a subsequent PVT input, receiving from the PVT model a subsequent PVT output, and determining a location to place a well based at least in part on the subsequent PVT output. The subsequent PVT input can comprise a subsequent API gravity and a subsequent gas-oil ratio (GOR). The PVT model can comprise a composition model. The subsequent PVT output can be generated based on the subsequent API gravity and the subsequent GOR.

Another method for predicting well behavior within a play using information available in the public domain is also described herein. The method can comprise the steps of inputting into a PVT model a subsequent PVT input, and receiving from the PVT model a subsequent PVT output. The subsequent PVT input can comprise a subsequent API gravity and a subsequent gas-oil ratio (GOR). The PVT model can comprise a composition model. The subsequent PVT output can comprise a subsequent composition table. The subsequent composition table can be generated by inputting the subsequent API gravity and the subsequent GOR into the composition model and receiving the subsequent composition table from the composition model.

In one embodiment, the composition model can be created while training a model. The model can be trained by feeding lab measurements into the model. The lab measurements can each comprise a measured API gravity, a measured GOR, a measured composition, and one or more lab experiments. The model can also be trained by tuning an equation of state of the model by dividing each of the measured compositions into component groupings. One or more groups of the component groupings can comprise variable attributes. The model can also be trained by tuning an equation of state of the model by adjusting the variable attributes to match the one or more laboratory experiments. The model can also be trained by adjusting Peneloux correction factors such that the measured API gravities and the measured GORs of the lab measurements can match calculated APIs and calculated GORs, and by creating the composition model.

In another embodiment, the PVT model can comprise a black oil table model. The subsequent PVT output can further comprise a subsequent black oil table that can be generated by the black oil table model. In such, the black oil table model can be generated by steps that can comprise inputting initial PVT inputs into the model after the model was trained, receiving initial black oil tables from the model, and curve-fitting the initial black oil tables to generate the black oil table model.

In another embodiment, the PVT model can comprise a molecular weight of oil (MW_{O}) equation. The subsequent PVT output can further comprise a subsequent MW_{O} that can be calculated using the MW_{O} equation. In such embodiment, the MW_{O} equation can be generated by steps that can comprise inputting initial PVT inputs into the model after the model was trained, receiving a plurality of MW_{O}s from the model, and curve-fitting the plurality of MW_{O}s to generate the MW_{O} equation.

In another embodiment, the PVT model can comprise a molecular weight of oil condensate (MW_{C}) equation. The subsequent PVT output can further comprise a subsequent MW_{C} that can be calculated using the MW_{C} equation. In such embodiment, the MW_{C} equation can be generated by steps that can comprise inputting initial PVT inputs into the model after the model was trained, receiving a plurality of MW_{C}s from the model, and curve-fitting the plurality of MW_{C}s to generate the MW_{C} equation.

In one embodiment, the PVT model can comprise a characteristic plot. Further, in one embodiment, the characteristic plot can be generated by steps that can comprise inputting initial PVT inputs into the model after the model was trained, plotting a plurality of characteristic lines with on an API gravity-GOR plot using outputs from the model, determining saturation line from the plurality of characteristic lines, and determining a sample validity line from the plurality of characteristic lines.

In one embodiment, the subsequent PVT output can comprise a determination as to whether a hydrocarbon sample associated with the subsequent PVT output is valid or invalid. That can be based at least in part on whether a subsequent characteristic line can be associated with the hydrocarbon sample that can be above the sample validity line. In another embodiment, the subsequent PVT output can comprise a determination as to whether a hydrocarbon sample associated with the subsequent PVT output is saturated or undersaturated. That can be based at least in part on whether a subsequent characteristic line can be associated with the hydrocarbon sample that can be below the saturation line. In one embodiment, the method can further comprise the step of screening out a hydrocarbon sample if the subsequent characteristic line can be above the sample validity line. In another embodiment, the method can further comprise the step of determining a location of a well based at least in part on whether the subsequent characteristic line can be below the saturation line.

In one embodiment, the method can further comprise the step of determining a location to place a well based at least in part on the subsequent black oil table, MW_{O}, MW_{C}, or P_{SAT}. Further, in another embodiment, the one or more attributes can comprise a critical temperature (T_{C}), a critical pressure (P_{C}), and/or an acentric factor. Lastly, in another embodiment, the composition model can be created while training a model, wherein the subsequent PVT input can further comprise an N₂, H₂S, and/or CO₂.

### BRIEF DESCRIPTION OF THE DRAWINGS

FIG. 1 illustrates a shale play comprising a plurality of wells.

FIG. 2 illustrates a block diagram of an exemplary computer system for implementing the present disclosure.

FIG. 3A illustrates memory of an exemplary computer system.

FIG. 3B illustrates laboratory measurements.

FIG. 3C illustrates a PVT input.

FIG. 3D illustrates PVT output.

FIG. 3E illustrates a PVT model.

FIG. 4 illustrates an exemplary method for predicting fluid behavior in an unconventional shale play.

FIG. 5 illustrates a step, obtaining suitable sets of lab measurements to be used for training a model used in predicting fluid behavior in a play.

FIG. 6A illustrates another step, training a model used in predicting fluid behavior in a play.

FIG. 6B illustrates a table of a composition divided into component groupings in a preferred embodiment.

FIG. 7 illustrates another step, feeding a trained model.

FIG. 8A illustrates an exemplary characteristic plot for oil.

FIG. 8B illustrates an exemplary characteristic plot for gas condensate.

FIG. 9A illustrates a composition table.

FIG. 9B illustrates a composition table histogram.

FIG. 10 illustrates an exemplary black oil table.

FIG. 11 illustrates a P_{SAT} map for a play.

FIG. 12 illustrates a headroom map.

FIG. 13 illustrates a molar depletion bubble map.

FIG. 14 illustrates an exemplary method for producing subsequent PVT outputs using subsequent PVT inputs using a PVT model.

FIG. 15 illustrates a PVT model processing subsequent PVT inputs to produce subsequent PVT outputs.

### DETAILED DESCRIPTION

Described herein is a system and method for predicting fluid behavior in an unconventional shale play.

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

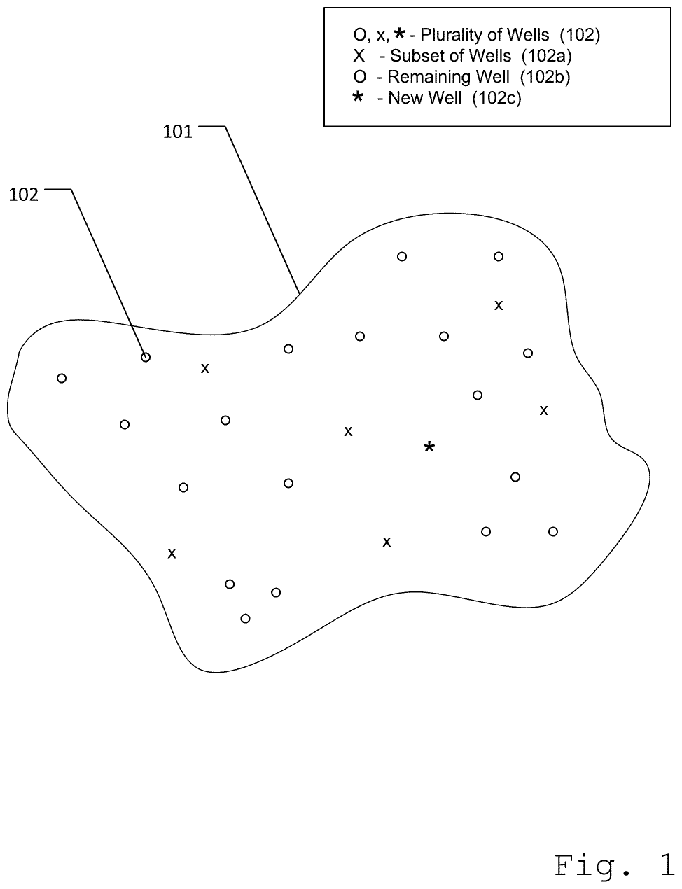

FIG. 1 illustrates a play 101 comprising a plurality of wells 102. Wells 102, in FIG. 1, have been marked with an “o”, “x”, or “*”. Each well of a subset of wells has been marked with “x” and is hereinafter referred as a subset well 102a. Each well of wells that have been drilled has been marked with “o” and is hereinafter referred as a remaining well 102b. A potential new well location 102c is marked with a “*”. Play 101 is an area in which hydrocarbon accumulations or prospects of a given type occur. For example, shale gas and tight oil plays in North America include the Barnett, Eagle Ford, Midland Wolfcamp, Bone Spring, Marcellus, and Utica, among many others. Play 101 has discernable aspects that are predominantly consistent across play 101, and such aspects are able to be represented with models. Play 101 can comprise as many as hundreds or even thousands of wells 102. A primary focus of this disclosure is to describe systems and methods for producing models that predict fluid behavior of hydrocarbons across play 101.

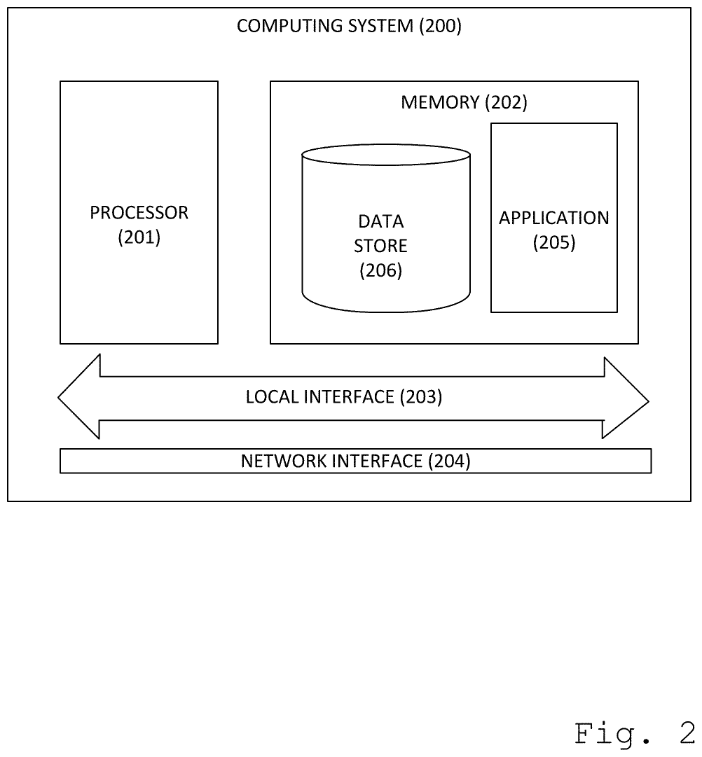

FIG. 2 illustrates a schematic block diagram of a computer system 200 according to an embodiment of the present disclosure. Computer system 200 having a processor 201 and a memory 202, both of which are coupled to a local interface 203. To this end, the computer system 200 can comprise, for example, at least one server, computer, or like device. Local interface 203 can comprise, for example, a data bus with an accompanying address/control bus or other bus structure as can be appreciated. Computer system 200 can also have a network interface 204 that allows computer system 200 to communicate with a network.

Stored in memory 202 described herein above are both data and several components that are executable by processor 201. In particular, stored in the memory 202 and executable by processor 201 are application 205, and potentially other applications. Also stored in memory 202 can be a data store 206 and other data. In addition, an operating system can be stored in memory 202 and executable by processor 201.

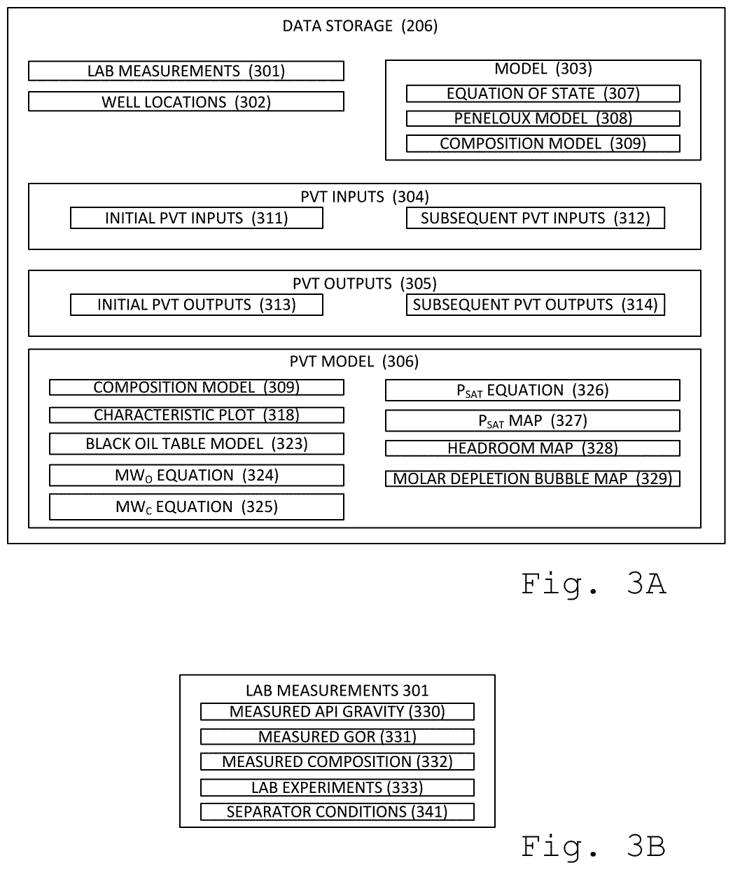

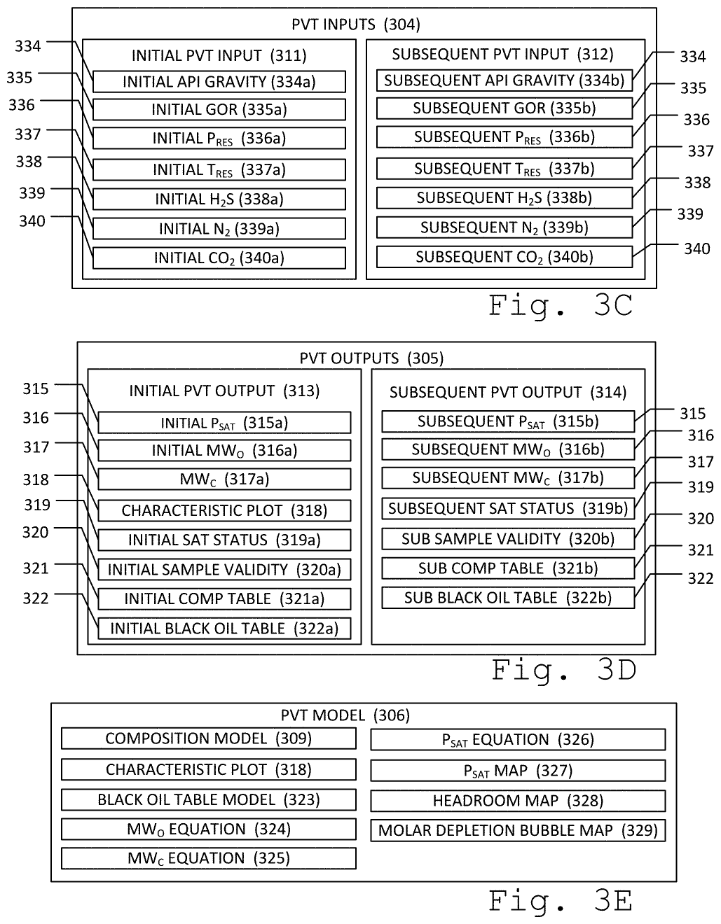

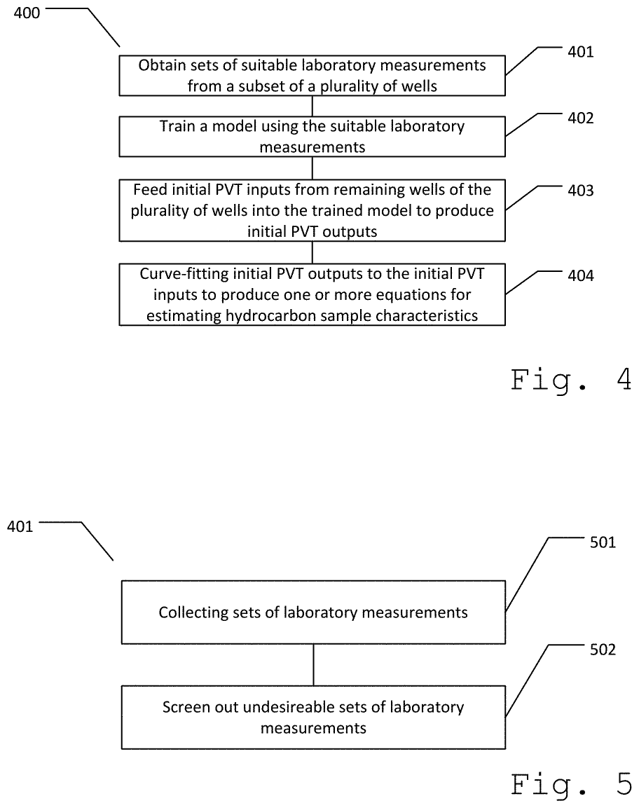

FIG. 3A illustrates data store 206. Data store 206 can store sets of lab measurement 301, well locations 302, a model 303, PVT inputs 304, PVT outputs 305, and a PVT model 306. Each set of lab measurements 301 comprises measurements from a hydrocarbon sample associated with one of subset wells 102a. For purposes of this disclosure, lab measurements 301 can be measurements taken in a lab or taken in the field. Each well location 302 is a location of one of the plurality of wells 102. Well location 302 can, in one embodiment, comprise a latitude and longitude. Model 303 can comprise an equation of state 307, a Peneloux model 308, and a composition model 309.

FIG. 3B illustrates lab measurements 301. Lab measurements 301 can comprise a measured API gravity 330, a measured GOR 331, a measured composition 332, lab experiments 333, and/or separator conditions 341.

FIG. 3C illustrates PVT inputs 304. Each PVT input 304 is well characteristic data from a hydrocarbon sample associated with one of the subsets of wells 102a and 102b. Each PVT input 304 can refer to either initial PVT inputs 311 and/or subsequent PVT inputs 312.

Each PVT input can include an API gravity 334, a gas-oil-ratio 335, a reservoir pressure (P_{RES}) 336, a reservoir temperature (T_{RES}) 337, an H₂S 338, an N₂ 339, and a CO₂ 340. H₂S 338 is a quantity in percentage moles of hydrogen-sulfide. N2 is a quantity in percentage moles of nitrogen. CO₂ is a quantity in percentage moles of carbon-dioxide. API gravity 334 can either be an initial API gravity 334a or a subsequent API gravity 334b, and GOR 335 can either be an initial GOR 335a or a subsequent GOR 335b. Similarly, P_{RES} 336 can either be an initial P_{RES} 336a or a subsequent P_{RES} 336b, and T_{RES} 337 can either be an initial T_{RES} 337a or a subsequent T_{RES} 337b. Lastly, H₂S 338 can either be an initial H₂S 338a or a subsequent H₂S 338b, N₂ 339 can either be an initial N₂ 339 a or a subsequent N₂ 339b, and CO₂ 340 can either be an initial CO₂ 340a or a subsequent CO₂ 340b.

FIG. 3D illustrates PVT outputs 305. PVT outputs 305 can refer to initial PVT outputs 313 and/or subsequent PVT outputs 314. For purposes of this disclosure, PVT outputs 305 an refer to sets of physical attributes for each hydrocarbon sample, the attributes dependent on pressure, volume, and/or temperature. PVT outputs 305 further refer to plots, graphs, and or maps based on one or more sets of those physical attributes along with well locations 302 of each of the plurality of wells 102 and/or data interpolated from the sets of physical attributes.

Each PVT output 305 can include a saturation pressure (P_{SAT}) 315, molecular weight of oil (MW_{O}) 316, molecular weight of oil condensate (MW_{C}) 317, a characteristic plot 318, a saturation status 319, a sample validity 320, a composition table 321, and/or a black oil table 321. Similarly, each set of subsequent PVT outputs 314 can comprise P_{SAT} 315, MW_{O} 316, MW_{C} 317, saturation status 319, sample validity 320, composition table 321, and/or black oil table 322. P_{SAT} 315 can either be an initial (P_{SAT}) 315a or a subsequent (P_{SAT}) 315b. Similarly, MW_{O} 316 can either be an initial MW_{O} 316a or a subsequent MW_{O} 316b, and MW_{C} 317 can either be an initial MW_{C} 317a or a subsequent MW_{C} 317b. Additionally, saturation status 318 can either be an initial saturation status 318a or a subsequent saturation status 318b, and sample validity 319 can either be an initial sample validity 319a or a subsequent MW_{C} sample validity.

FIG. 3E illustrates PVT model 306. PVT model 306 can comprise multiple constituents. Composition model 309 can be a composition model constituent of PVT model 306. Characteristic plot 318 can be a characteristic plot constituent of PVT model 306. A black oil table model 323 can be a black oil table model constituent of PVT model 306. An MW_{O} equation 324 can be an MW_{O} equation constituent of PVT model 306. An MW_{C} equation 325 can be an MW_{C} constituent equation constituent of PVT model 306. A P_{SAT} equation 326 can be a PSAT equation constituent of PVT model 306. A P_{SAT} map 327 can be a PSAT map constituent of PVT model 306. A headroom map 328 can be a headroom map constituent of PVT model 306. Lastly, a Molar Depletion Bubble Map 329 can be a molar depletion bubble map constituent of PVT model 306.

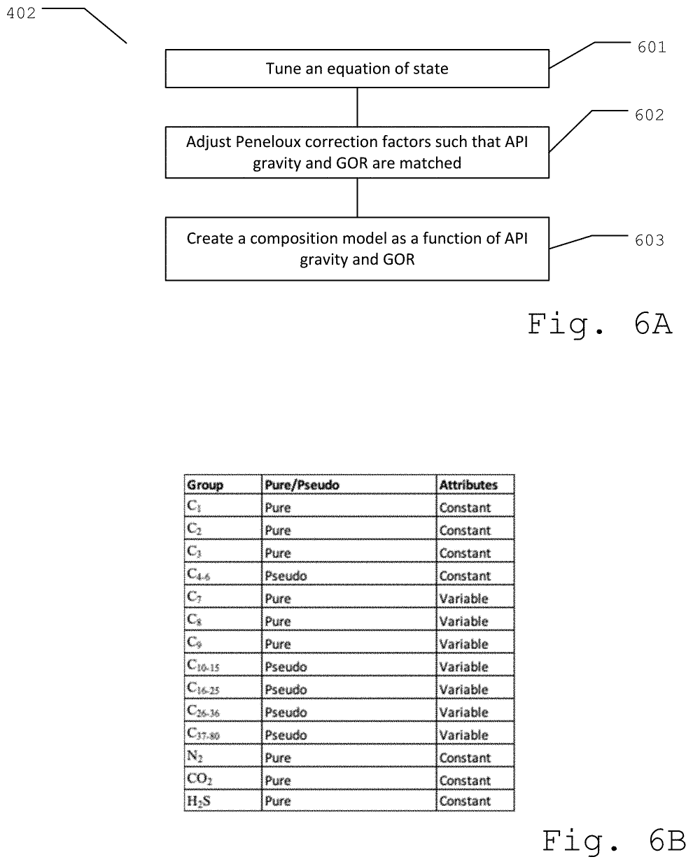

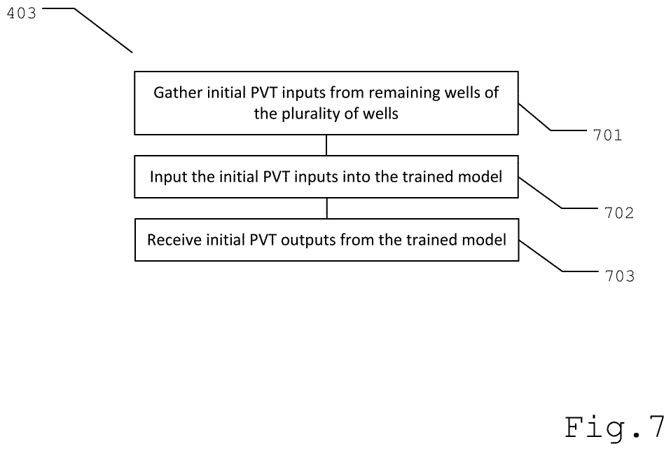

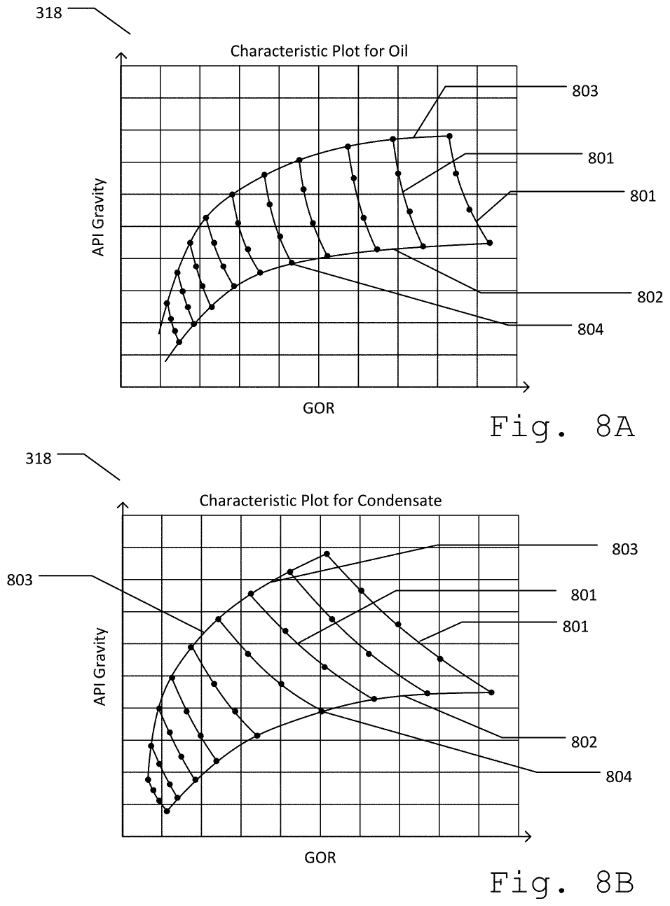

FIG. 4 illustrates an exemplary method 400 of predicting fluid behavior in play 101. A first step 401 of method 400 is to obtain sets of lab measurements 301 that are suitable, each set of lab measurements from one of subset wells 102a, that can be used to train model 303. When each well 102a is drilled or sometime thereafter, a hydrocarbon sample can be gathered, and analysis of the hydrocarbon sample can be performed to obtain suitable lab measurements 301 for training model 303, as discussed further below and illustrated in FIG. 5. A second step 402 of method 400 is to train model 303. Model 303 can be trained by giving model 303 lab measurement sets 301 from subset wells 102a, as described further below and illustrated in FIG. 6. In a third step 403 of method 400, after model 303 is trained, initial PVT inputs 311 from each hydrocarbon sample from remaining wells of the plurality of wells 102 can be fed into the model 303 after it has been trained to produce initial PVT outputs 313 as described further below and illustrated in FIG. 7. In fourth step 404 of method 400, initial PVT outputs 313 can be curve-fitted to the initial PVT inputs 311 to produce one or more equations for estimating hydrocarbon sample characteristics.

FIG. 5 illustrates first step 401, obtaining suitable sets of lab measurements 301 to be used for training model 303 used in predicting fluid behavior in play 101. First step 401 can comprise two sub-steps, including collecting sets of lab measurements 301 and screening out undesirable sets of lab measurements 301.

In a first sub-step 501 of first step 401, sets of lab measurements 301 are collected. Each set of lab measurements 301 can comprise measured API gravity 330, measured GOR 331, measured composition 332, lab experiment 333, and/or separator conditions 341. Examples of lab experiment 333 include results from the following:
a. composition measurement;
b. viscosity measurement
c. constant composition expansion (CCE) test;
d. differential liberation;
e. constant volume depletion (CVD) test; and
f. separator test.

Composition Measurement:

Using a chromatogram, the weight percentage of individual components (C1, C2 etc. . . . ) can be estimated in oil and gas.

Viscosity:

The viscosity of a fluid sample can be measured using a viscometer.

Constant Composition Expansion (CCE):

CCE analysis can be performed to determine a bubble point of a fluid sample. The fluid sample can be introduced into a PV cell and the pressure can be raised to a high value. The pressure can be reduced in stages, and at each stage, the volume recorded. Initially, the oil volume changes slowly until the bubble point is reached. After the bubble point, gas comes out of solution and overall compressibility increases significantly and therefore leading to large volume changes. The temperature throughout the experiment is maintained constant, usually at the reservoir temperature.

Differential Liberation:

In differential liberation, a fluid sample can be introduced into a PVT cell and the pressure is raised to the bubble point pressure determined by the CCE. The pressure can be reduced in stages and all the liberated gas can be removed from the oil. Therefore, the composition of the fluid sample in the PV cell changes at each step. The temperature throughout the experiment is maintained constant, usually at the reservoir temperature. This experiment can yield the following: oil formation volume factor, solution gas/oil ratio, oil density at cell conditions, gas formation volume factor, Z-factor and/or gas gravity.

Constant Volume Depletion (CVD):

Reservoir fluid (gas condensate or volatile oil) is introduced into the PV cell at the saturation pressure and reservoir temperature. The cell volume is increased, which decreases the pressure and the phases separate. Then, gas is let out of the cell to bring the cell volume back to the original volume while maintaining the pressure. This is repeated until the pressure drops to around 1,500-5.00 psi. The liquid volume in the cell as a percent of the liquid volume at saturation pressure, molar composition of the depleted gas, molar amount of the gas depleted as a percentage of the gas initially in the cell and the Z-factor at cell conditions are measured. Considering that the reservoir has an almost constant volume, this experiment mimics the production from the reservoir where pressure decreases as material is removed while volume and temperature remain almost constant.

Separator Test:

This test is performed to simulate fluid behavior as it passes through various stages of separation. Usually, two to three stages of separation are used, with the last stage at standard temperature and pressure. The pressure and temperature of these stages are set to represent the desired or actual surface separation facilities. A fluid sample starting at reservoir temperature and bubble-point pressure is brought to the conditions of the first stage separator. The liberated gas is removed and volume and gas gravity at standard conditions are measured. The liquid is transferred to the next separator which is at a lower temperature and pressure compared to the previous one. The same process can be repeated for each stage of separation. This experimental data can then be used to determine the oil formation volume factor and gas solubility.

Hydrocarbon samples are collected at an early stage of well life (within first 1-2 months). The hydrocarbon samples need to represent the reservoir fluids in their initial condition. There are two common methods to collect fluid samples: downhole sampling and surface recombination. For downhole sampling, special devices are run on a wireline to the reservoir depth and a sample is collected from the subsurface well stream at bottom-hole conditions. For surface recombination, separate volumes of oil and gas are takes at separator conditions and recombined to obtain a representative insitu fluid sample. The recombination ratio is determined based on the producing GOR.

Often, lab measurements 301 can be collected from public sources having information on wells across play 100. Public sources include but are not limited to technical literature and state reporting agencies. Further, lab measurements 301 can be received from operators who have previously collected data. In a preferred embodiment, sets of lab measurements 301 from ten or more wells 102 are used with equation of state 307 to train model 303, and the lab measurements 301 include results from at least one laboratory experiment.

In a second sub-step 502, the quality of lab measurements 301 can be checked in one or more ways. First, lab measurements 301 can be checked to see if calculated or measured bottom-hole pressure (P_{bhp}) is greater than saturation pressure at reservoir temperature. If (P_{bhp}) is greater saturation pressure at reservoir temperature, the hydrocarbon sample is valid. Otherwise, it is invalid and cannot be used to train model 303. Second, lab measurements 301 can be checked for any anomalous GOR-API ratios. The recombination GOR in the PVT report needs to be close to the producing GOR for the well at the time of sampling. Third, the composition can be reviewed to determine if it is out of trend. A composition is out of trend if the molar composition of any given component of a given sample, when compared against the other samples, is a statistical outlier. Lastly, lab measurements 301 can be reviewed to ensure that the hydrocarbon samples were collected at the surface and recombined. Some operators may collect bottom-hole hydrocarbon samples because it is the norm for conventional reservoirs. However, in shale and tight oil reservoirs, such samples yield a heavier sample compared to the in-situ reservoir fluid because of gravity. For this reason, such bottom-hole samples in one embodiment can be excluded.

FIG. 6A illustrates second step 402, training model 303 used in predicting fluid behavior in play 101. Second step 402 can comprise three sub-steps including tuning equation of state 307, adjusting Peneloux correction factors such that measured API gravity 330 and measured GOR 331 are matched with calculated values, and creating composition model 309 as a function of variable API gravity and variable GOR.

In a first sub-step 601 for second step 402, equation of state 307 can be tuned such that all components across all of the subset wells 102a have the same properties. For tuning equation of state 307, a sample composition is divided into a plurality of groups of hydrocarbons and non-hydrocarbons. Each group represents a component or pseudo-component. Each group can have attributes that are either constant or variable. For tuning the equation of state 307, there are multiple ways that the components can be combined to properly characterize equation of state 307. A choice of pseudo-components can be made such that within the pseudo-components, there is not too much of variation in true boiling points among the components that have been grouped together.

FIG. 6B illustrates a table of a composition divided into component groupings in a preferred embodiment. Attributes can include, but are not limited to a critical temperature (TO, a critical pressure (Tₚ) and an acentric factor. Variable attributes are adjusted to match lab experiments 333 and/or separator conditions 341. Although groups C7, C8, and C9 are pure components, each has multiple isomers that cause attributes within such groupings to be variable.

In a second sub-step 602 of second step 402, a Peneloux correction factor can be readjusted such that measured API gravity 330 and measured GOR 331 from lab measurements 301 are matched to calculated results. For each subset well 102a, Peneloux Correction Factor (Cₚₑₙ) of attributes of C7+ component groupings can be adjusted to match the multi-stage separator experiments' measured API 330 and measured GOR 331 by using a constant multiplication factor. In one embodiment, a function can then be created to derive a Cₚₑₙ of C7+ components for any given variable API gravity and variable GOR combination. In a preferred embodiment, the function is a two-dimensional cubic interpolation function.

In a third sub-step 603 of second step 402, composition model 309 as a function of variable API gravity and variable GOR can be created. For purposes of this disclosure, API gravity can refer to API gravity or any such representation of density of oil or condensate. Similarly, GOR represents gas-oil-ratio or any such representation. As an example, composition model 309 for oil for Bone Spring play in the Delaware Basin for a set of components and pseudo components that we have assumed from Step 3 is as shown below. For purposes of this disclosure variable API gravity is shown in equations as “°API,” and variable GOR is shown as “GOR.”

C₁=−175.533+0.194*GOR/1000+9.995*°API−1.454*(GOR/1000)²+0.268*GOR/1000*°API−0.117*°API²;

C₂=−35.191+1.567*GOR/1000+1.918*°API−0.311*(GOR/1000)²+0.011*GOR/1000*°API−0.022*°API²;

C₃=−23.084−0.117*GOR/1000+1.334*°API−0.154*(GOR/1000)²+0.022*GOR/1000*°API−0.016*°API²;

C₄₋₆=−26.726−0.596*GOR/1000+1.565*°API−0.158*(GOR/1000)²+0.031*GOR/1000*°API−0.019*°API²;

C₇=−11.077−1.063*GOR/1000+0.670*°API−0.028*(GOR/1000)²+0.024*GOR/1000*°API−0.008*°API²;

C₈=−5.229−3.229*GOR/1000+0.628*°API+0.078*(GOR/1000)²+0.052*GOR/1000*°API−0.009*°API²;

C₉=0.097−2.551*GOR/1000+0.297*°API+0.086*(GOR/1000)²+0.038*GOR/1000*°API−0.005*°API;

C₁₀₋₁₅=30.273−7.389*GOR/1000−0.497*°API+0.415*(GOR/1000)²+0.085*GOR/1000*°API+0.002*°API²;

C₁₆₋₂₅=86.447−0.717*GOR/1000−3.659*°API+0.508*(GOR/1000)²−0.067*GOR/1000*°API+0.043*°API²;

C₂₆₋₃₆=e\hat{ }(7.366−0.888*GOR/1000−0.234*°API+0.085*(GOR/1000)²−0.0002*GOR/1000*°API+0.002*°API²); and

C₃₇₋₈₀=e\hat{ }(10.603−1.001*GOR/1000−0.369*°API+0.111*(GOR/1000)2−0.003*GOR/1000*°API+0.004*°API²).

Similar composition models 309 can be created for any choice of components and pseudo-components using the steps outlined in this disclosure. Irrespective of the choice of components and pseudo-components, since the petroleum system for each self-sourced play is different, each play 101 therefore would have a separate composition model 309 that describes the hydrocarbons generated in the play. A similar set of equations also define the composition of components and pseudo-components for condensates in the Bone Spring play. Within play 101, the fluid maturity varies geographically. Therefore, there are multiple insitu fluid compositions. Using composition model 309 for play 101, composition model 309 generated can be used to determine fluid composition of samples across play 101.

Composition model 309 described above along with equation of state 307 that has been tuned and the readjusted Peneloux model 308 can be used to create initial PVT outputs 313, a large data set representing fluid compositions associated with varying maturities at various points in the reservoir, as further described below. These compositions yield various combinations of API gravity and GORs for oil and condensate systems representing all the possible combinations of reservoir fluids and separator conditions for play 101.

FIG. 7 illustrates third step 403, feeding model 303. Third step 403 can comprise three sub-steps, including obtaining initial PVT inputs 311 from remaining wells 102b, inputting initial PVT inputs 311 into model 303, and receiving initial PVT outputs 313 from model 303.

A first sub-step 701 can comprise obtaining initial PVT inputs 311 for the remaining wells of the plurality of wells. Initial PVT inputs 311 can be available for each well 102. Initial PVT inputs 311 can include but are not limited to
a. initial API gravity 334a,
b. initial GOR 335a,
c. initial P_{RES} 336a,
d. initial T_{RES} 337a,
e. initial H₂S 338a,
f. initial N₂ 339a, and/or
g. initial CO₂ 340a.

For purposes of this disclosure, API gravity 334 and GOR 335 are significant inputs because such PVT inputs 304, in some embodiments can be used to complete all calculations of PVT outputs 305 in PVT model 306. In other embodiments, it is sometimes necessary to have other inputs such as initial P_{RES} 336a, initial T_{RES} 337a, initial H₂S 338a, initial N₂ 339a, and/or initial CO₂ 340a. For example, some compositions may not have H₂S, N₂, or CO₂ components. As such, it would not be necessary to have those within PVT input 304 to determine composition. In another composition containing CO₂ as a component, CO₂ would be a useful PVT input 304.

A second sub-step 702 can comprise inputting initial PVT inputs 311 into model 303. In a preferred embodiment, all such initial PVT inputs 311 listed above are used with model 303. Such data is obtainable from the public domain or from well operators. Once received, model 303 can use tuned equation of state 307, adjusted Peneloux model 308, and composition model 309, to produce initial PVT outputs 313. In a preferred embodiment, equation of state tuned 307 is Peng-Robinson (1978) with Peneloux volume correction.

A third sub-step 703 can comprise receiving initial PVT outputs 313 from model 303. Model 303, once trained, can calculate initial PVT outputs 313 using tuned equation of state 307, the Peneloux correction model 308, temperature, and composition model 309. Examples of initial PVT outputs 313 can include, but are not limited to:
a. initial Pₛₐₜ 315a for each hydrocarbon sample;
b. initial MW_{O} 316a for each oil hydrocarbon sample;
c. initial MW_{C} 317a for each condensate hydrocarbon sample;
d. characteristic plot 318;
e. initial saturation status 319a—a determination whether each hydrocarbon sample is saturated or under-saturated;
f. initial sample validity 320a—a determination of hydrocarbon sample validity or if there exists a sampling error;
g. initial composition table 321a of insitu fluid; and
h. initial black oil table 322a for each sample.

P_{SAT} 315 for a given temperature is the pressure at which a single-phase hydrocarbon fluid (oil or gas) begins to separate into two phases. For oil, the pressure at which gas begins to come out of solution and form bubbles is known as the bubble-point pressure. For wet gas, the pressure at which condensate begins to condense is called dewpoint pressure.

MW_{O} 316 at stock tank can be generated for various separator conditions. Similarly, MW_{C} 317 at stock tank can also be generated for various separator conditions.

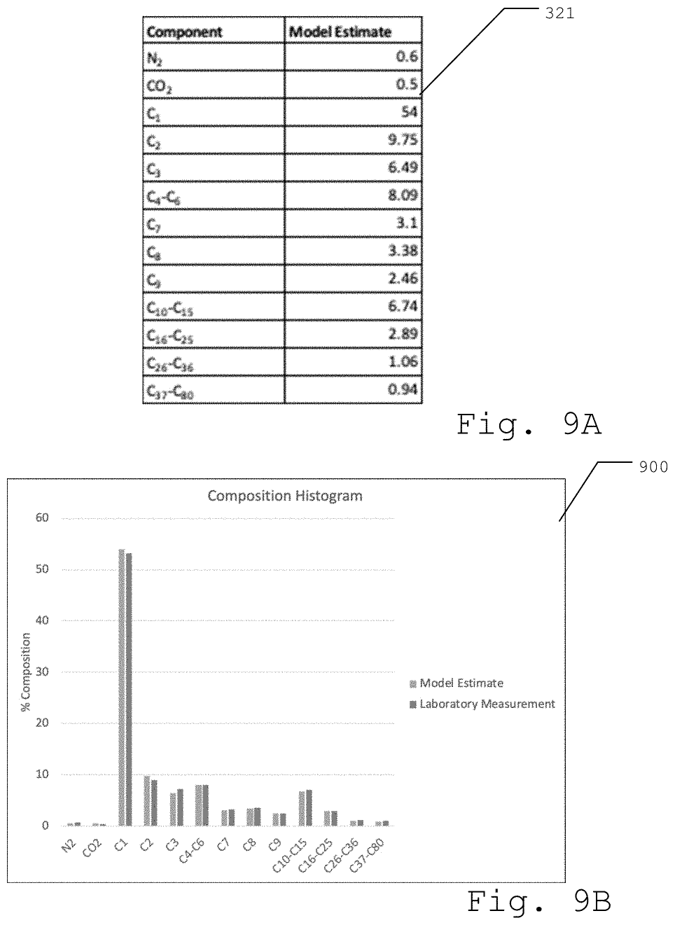

FIG. 8A illustrates an exemplary characteristic plot 318 for oil. FIG. 8B illustrates an exemplary characteristic plot 318 for gas condensate. Characteristic plot 318 plots API gravity 334 vs. GOR 335 to form a characteristic point 804. Each such reservoir has a characteristic plot of GOR and API relationships. Characteristic plot 318 can comprise a plurality of characteristic lines 801 that can be formed based on characteristic points 804 considered at different separator conditions. Each characteristic line 801 denotes one hydrocarbon sample composition separated at different separator pressure and temperature conditions. Characteristic plot 318 is bounded by two lines: a saturation limit line 802 and a practical sample validity line 803.

Once characteristic plot 318 is made, it can be used to make a determination of a saturation status 319, whether each hydrocarbon sample is saturated or under-saturated. If an API-GOR combination lies below saturation limit line 802, the well stream fluid is saturated. This can either be because the reservoir is saturated to begin with or the sample has been collected after the bottom-hole pressure has fallen below the saturation pressure. Saturation limit line 802 is obtained when a well stream is flashed at atmospheric/standard conditions (14.7 psia at 60° F.).

Once characteristic plot 318 is made, it can also be used to make a determination of hydrocarbon sample validity 320, whether there exists any sampling error or not. In one embodiment, practical sample validity line 803 can be obtained when the well stream is separated with a three-stage separation with the following conditions—500 psia and 60° F., 100 psia and 60° F., and standard conditions. Such separation can represent the upper practical economic limit of separation. Normally, fluids in shale and tight gas plays are separated using a one or two stages of separation. The upper limit of separation would be a near ideal separation with all the light and intermediary ends being retained in the oil phase. Such a separation results in lower gas volume (lower GOR) due to all the intermediaries ending up in the oil phase and a lower density oil (higher API gravity). Any combination of API-GOR above this practical separation limit line imply data reporting issues since such a combination is not possible for the given reservoir.

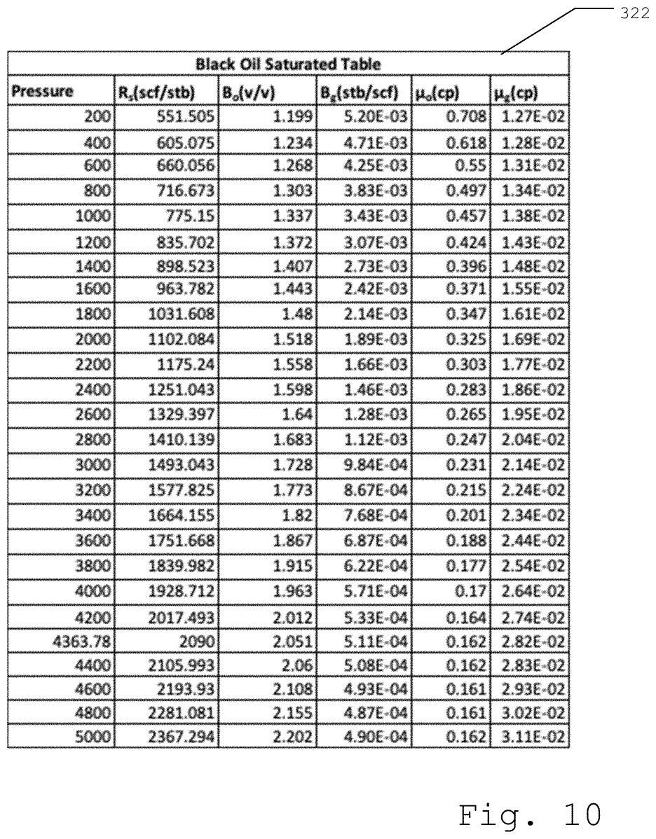

FIG. 9A illustrates composition table 321. Composition table 321 describes for each component its percentage of the composition based on moles. For purpose of this disclosure, composition table 321 need not be have a column or row structure, but instead must only merely describe a composition of a hydrocarbon sample by its components.

FIG. 9B illustrates a composition histogram 900. A primary purpose of this disclosure is to estimate compositions of a hydrocarbon sample that can replace the need for expensive laboratory testing. FIG. 7B illustrates a comparison between component proportions calculated using a method of this disclosure compared to laboratory results. As shown by FIG. 7B, methods of this disclosure are capable of accurately predicting fluid composition.

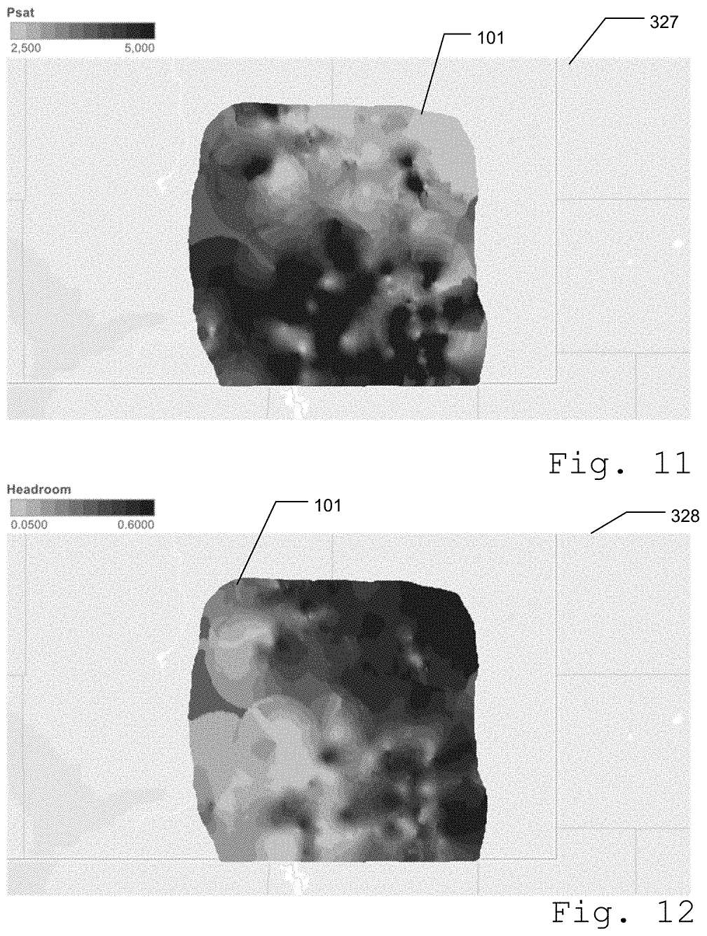

FIG. 10 illustrates an exemplary black oil table 322. Black oil properties are physical properties of a hydrocarbon mixture that define expansion and flow aspects of the fluid at various pressure and temperature conditions. The black oil properties are a formation volume factor for oil (Bₒ), a formation volume factor for gas (B_{g}), a solution gas oil ratio (Rₛ), an oil viscosity (μₒ), a gas viscosity a solution condensate to gas ratio (Rᵥ). Bₒ is the ratio of volume of oil at a given pressure and temperature to the volume of oil at standard pressure and temperature conditions (14.7 psia at 60° F.). B_{g} is a ratio of volume of gas at a given pressure and temperature to the volume of gas at standard pressure and temperature conditions. Rₛ is the ratio of volume of gas dissolved in a given volume of oil at any given pressure and temperature. Viscosity μₒ is the quantity expressing the magnitude of internal friction of oil. Viscosity μ_{g} is the quantity expressing the magnitude of internal friction of gas. The greater the viscosity, slower or sluggish the movement of a fluid, oil or gas, across a given pressure drop. Rᵥ is the amount of condensate dissolved in per unit volume of gas.

If oil, black oil properties can comprise R_{S}, μₒ, μ_{g}, Bₒ, and B_{g} as a function of P and T. If condensate, R_{V}, R_{S}, μₒμ_{g}, Bₒ, B_{g} as a function of P and T.

In fourth step 404, initial PVT outputs 313 can be curve-fitted to initial PVT inputs 304 to produce one or more equations for estimating hydrocarbon sample characteristics. In particular, initial PVT outputs 313 can be curve-fitted to produce:
a. black oil table model 323;
b. MW_{O} equation 324;
c. MW_{C} equation 325;
d. P_{SAT} equation 326;
e. P_{SAT} map 327 for play 101;
f. headroom map 328; and
g. molar-depletion bubble map 329.

After black oil tables 322 are generated for each hydrocarbon sample, one or more techniques can be used to build black oil table model 323 that correlate the values in black oil tables 322. Techniques can include but are not limited to:
a. a multiple linear regression;
b. a Heuristic search using a genetic algorithm and local optimization to improve the predictability of black oil table model 323;
c. a decision-tree based correlation using Ada-boost; and/or
d. a Gaussian process regression.

Techniques can be mixed-and-matched to improve the correlation and the predictability of black oil table model 323 using cross-validation and blind testing. In one embodiment, a prediction can be performed using hierarchical modelling. Further in one embodiment, such hierarchical model can have two phases. In a first phase, the hierarchical model can be predicted at defined input points with which the hierarchical model was originally built. In a second phase, interpolation techniques can be employed to predict undefined input points. Lastly, black oil table model 323 can be plotted visually inspected to check its validity. Once created, black oil table model 323 can receive subsequent PVT inputs 312 related to a new hydrocarbon sample from play 101 and produce subsequent black oil table 322b associated with the new hydrocarbon sample.

After MW_{O} 316 is generated for each oil hydrocarbon sample, they too can be curve-fitted using techniques such as linear regression to correlate MW_{O} 316 values to initial PVT inputs 311. Such techniques can produce MW_{O} equation 324 that is a function of variable API and variable GOR to produce subsequent MW_{O} 316b. An exemplary MW_{O} equation 324 is as follows:

Subsequent MW_{O} 316b=1168.648+0.005*GOR−39.856*°API+0.000002*GOR²−0.0005*GOR*°API+0.404*°API².

After initial composition table 321 and initial MW_{C} 317a are generated for each condensate hydrocarbon sample, each initial MW_{C} 317a too can be curve-fitted using techniques such as linear regression to correlate initial MW_{C} 317 values. Such techniques can produce MW_{C} equation 325 that is a function of variable API, variable GOR, and C₁ (which is a function of variable API and variable GOR), N₂, and/or CO₂. An exemplary MW_{C} equation 325 is as follows:

Subsequent MW_{C} 317b=919.446−8.667*C₁−5.924*N₂−5.671*CO₂+0.002*GOR−13.408*°API+0.005*C₁²+0.072*N₂*C₁+0.137*°API*C₁+0.041*CO₂*N₂+0.016*CO₂²+0.091*°API*CO₂−0.000000001*GOR²−0.00003*°API*GOR+0.0003*°API².

After initial composition table 321a and initial P_{SAT} 315a are generated for each oil hydrocarbon sample, initial P_{SAT} 315a values too can be curve-fitted using techniques such as linear regression to correlate initial P_{SAT} 315a values of oil hydrocarbon samples. Such techniques can produce P_{SAT} equation 326 that in one embodiment is a function of Temperature, API gravity, GOR, molar percentages of N₂ and CO₂. An exemplary P_{SAT} equation 326 is as follows:

Subsequent P_{SAT} 315b=−13105.309+0.311*GOR+727.386*°API−8.0716*T+21.112*N₂−35.782*CO₂−0.0002*GOR²+0.026*°API*GOR−0.0002*T*GOR−0.008*N₂*GOR−0.007*CO₂*GOR−9.946*°API²+0.477*T*°API+3.472*N₂*°API+0.501*CO₂*°API−0.004*T²−0.080*N₂*T+0.014*CO₂*T+2.446*N₂²+3.662*CO₂*N₂+5.713*CO₂²

After initial composition table 321 and initial P_{SAT} 315a are generated for each condensate hydrocarbon sample, each initial P_{SAT} 315 too can be curve-fitted using techniques such as linear regression to correlate initial P_{SAT} 315 values for condensate hydrocarbon samples. Such techniques can produce P_{SAT} equation 326 that in one embodiment is a function of variable reservoir temperature, variable API gravity, variable GOR, and molar percentages of variable N₂ and variable CO₂. An exemplary P_{SAT} equation 326 is as follows:

Subsequent P_{SAT} 315b=6720.851+132.321*N₂−0.036*GOR−59.577*°API+10.641*T+4.209*N₂²−0.0006*GOR*N₂−0.222*T*N₂−5.962*CO₂²+0.1*T*CO₂+0.00000005*GOR²+0.0006*°API*GOR−0.00007*T*GOR+0.004*°API²−0.023*T².

FIG. 11 illustrates P_{SAT} map 327 of play 101. P_{SAT} map 327 can be created by mapping in space each P_{SAT} 315 of initial PVT outputs 313 using well locations 302 associated with well 102 for which P_{SAT} 315 is calculated. Next, curve-fitting algorithms such as interpolation methods can be employed to produce an estimated P_{SAT} 315 for each latitude and longitude between wells 102a and 102b in play 101. P_{SAT} map 327 of play 101 can be generated by assigning visual representations to values or ranges of values of P_{SAT} 315 data and estimated P_{SAT} 315 data. In one embodiment, each visual representation can be a unique hue, tint, tone, or shade. In another embodiment, each visual representation can be a unique shape.

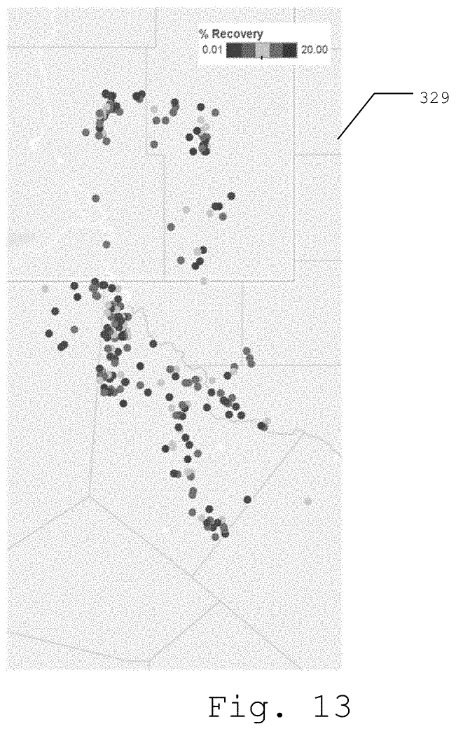

FIG. 12 illustrates headroom map 328 of play 101. Headroom is the difference between the initial reservoir pressure (Pᵢ) and the P_{SAT} 315 of insitu reservoir fluid. First headroom can be calculated for each hydrocarbon sample associated with wells 102a and 102b, next, each headroom value can be plotted in space using well locations 302 associated with well 102a or 102b for which headroom is related. Next, curve-fitting algorithms such as interpolation methods can be employed to produce an estimated headroom for each latitude and longitude between wells 102 in play 101. Headroom map 328 of play 101 can be generated by assigning visual representations to values or ranges of values of headroom and estimated headroom. In one embodiment, each visual representation can be a unique hue, tint, tone, or shade. In another embodiment, each visual representation can be a unique shape.

FIG. 13 illustrates molar depletion bubble map 329. Molar depletion bubble map 329 is a map illustrating a number of moles produced from each well. Molar depletion bubble map 329 of play 101 can be generated by assigning visual representations to values or ranges of values of moles produced at each well 102a or 102b, and displaying that visual representation at well location 302 associated with each on molar depletion bubble map 329. In one embodiment, each visual representation can be a unique hue, tint, tone, or shade. In another embodiment, each visual representation can be a unique shape. In another embodiment, visual representation could be a size of a shape.

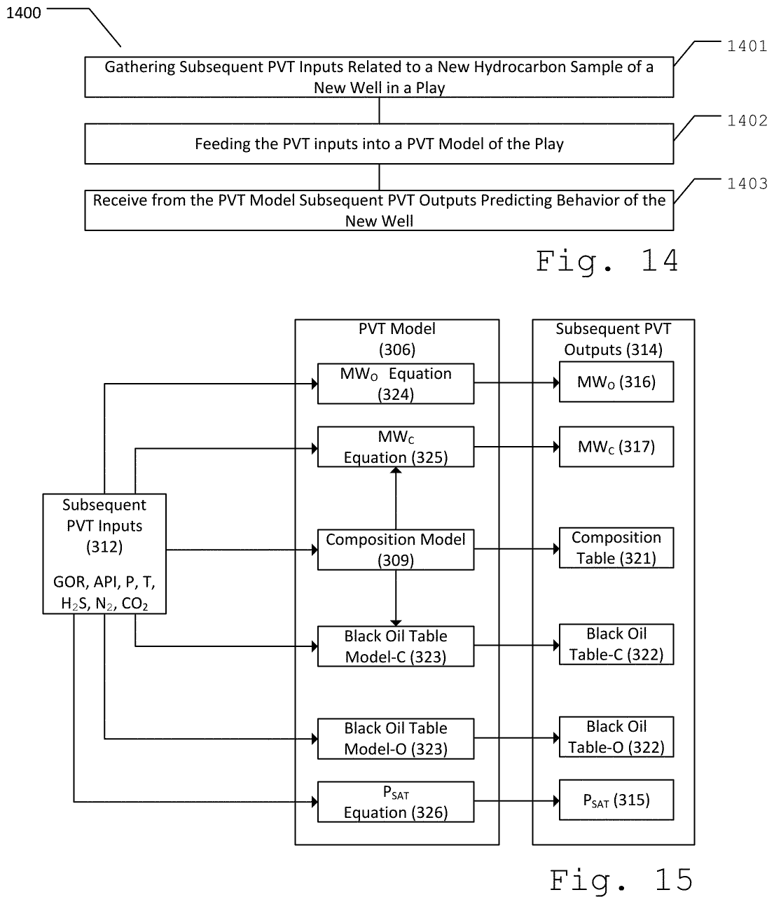

FIG. 14 illustrates an exemplary method 1400 for predicting behavior of new well 102c within play 101 using PVT model 306. In a first sub-step 1401, subsequent PVT inputs 312 related to a new hydrocarbon sample of new well 102c within play 101 can be obtained.

In a second sub-step 1402, subsequent PVT inputs 312 can be inputted into PVT model 306. PVT model 306 can then process subsequent PVT inputs 312 to produce subsequent PVT outputs 314, as described below.

In a third sub-step 1403, subsequent PVT outputs 314 can be received from PVT model 306. Subsequent PVT outputs can predict the behavior of well 102c.

FIG. 15 illustrates PVT model 306 processing subsequent PVT inputs 312 to produce subsequent PVT outputs 314. Subsequent PVT inputs 312 can include but are not limited to
a. Subsequent API gravity 334b,
b. subsequent GOR 335b,
c. subsequent P_{RES} 336b,
d. subsequent T_{RES} 337b,
e. subsequent H₂S 338b,
f. subsequent N₂ 339b, and/or
g. subsequent CO₂ 340b.

In one embodiment, PVT model 306 can comprise
a. composition model 309,
b. black oil table model 323,
c. MW_{O} equation 324,
d. MW_{C} equation 325, and/or
e. P_{SAT} equation 326.

Further, in one embodiment, subsequent PVT outputs 314 of PVT model 306 can be as follows:
a. subsequent composition table 321b
b. subsequent black oil table 322b,
c. subsequent MW_{O} 316b,
d. subsequent MW_{C} 317b, and/or
e. P_{SAT} 315b.

Subsequent PVT outputs 314 can be produced by PVT model 306 as follows. First, upon receiving subsequent PVT inputs 312, PVT model 306 can generate composition table 321 using subsequent API gravity 334b and subsequent GOR 335b from subsequent PVT inputs 312, with composition model 309. Second, PVT model 306 can calculate subsequent P_{SAT} 315b using temperature, subsequent API 334b, subsequent GOR 335b, N₂ moles, and/or CO₂ moles, with P_{SAT} equation 326. Third, if, hydrocarbon sample is an oil sample, PVT model 306 can calculate subsequent MW_{O} 316b using subsequent API 334b and subsequent GOR 335b, with MW_{O} equation 324. However, if hydrocarbon sample is a condensate sample, PVT model 306 can calculate MW_{C} 317 using subsequent API 334b and subsequent GOR 335b, and/or C₁ from composition table 321. Lastly, PVT model 306 can produce subsequent produce black oil table 322b using subsequent PVT inputs 312 with black oil table model 323.

Although not shown in FIG. 15, PVT model 306 can further comprise characteristic plot 318. Characteristic plot 318 can be used to determine whether a hydrocarbon sample is saturated or undersaturated, or whether it is invalid, as described above.

PVT model 306, by producing PVT output 305 is a virtual laboratory, in that it replaces the need for performing expensive lab processes. Instead, by only knowing basic information such as API gravity 334 and GOR 335 of a hydrocarbon sample, all PVT outputs 305 can be known about the hydrocarbon sample without sending it to a lab.

PVT properties play an important role across various disciplines in the upstream oil and gas industry, right from exploration to sale of hydrocarbons. PVT model 306 can, in one embodiment be used to determine a location to drill a well within play 101. At least three significant considerations exist when considering well placement. First, will a new well produce oil, gas, or some mixture? What are the flow properties? Third, how much oil/gas can be produced from the well.

Whether a well should have gas, oil or some mixture is dependent on a company's needs and is demand driven. For example, if a company is selling predominantly oil, it will likely wish to drill a well that will produce oil. Characteristic plot 318 can be used to determine the phase of a reservoir within play 101, and as such can be determinative as whether a well should be drilled for production. Similarly, P_{SAT} 315 can be used to determine if fluid is single-phase or multiphase. Usually, in a shale/tight oil reservoir, multiphase fluids in the reservoir will lead to lower productivity. As such, it is also useful in determining whether a well should be drilled for production.

Next, flow properties could be considered. Flow properties like viscosity and compressibility determine well productivity. Such can be estimated using the black oil table 322 and calculation method known in the art.

A next question relevant to locating a production well is the number of available hydrocarbons in a potential production well. Available hydrocarbons in moles can be determined by calculating total hydrocarbons initially in a well's expected drainage area and then subtracting out hydrocarbons already extracted. The volume of hydrocarbons already extracted in a given area is readily ascertainable from the public domain. Calculating initial hydrocarbons in a well can be completed using methods taught in this disclosure. First, total moles of hydrocarbons can be calculated by adding the total moles of oil and adding to total moles of gas. One can first obtain a volume of oil and volume of gas, and then convert each to moles before adding.

For an oil reservoir, volume of oil can be calculated using Bo of black oil table 322. An exemplary formula for volume of oil is: Vo=(Area of Site×thickness×porosity×saturation of oil)/B_{O}.

Similarly, volume of gas in an oil reservoir can be calculated using R_{S} of black oil table 322. An exemplary formula for volume of gas is: Vg=(Area of Site×thickness×porosity×saturation of oil)×Rs/B_{O}.

For a gas reservoir, volume of gas can be calculated using B_{g} of black oil table 322. An exemplary formula for volume of gas is: Vg=(Area of Site×thickness×porosity×saturation of gas)/Bg.

Similarly, volume of condensate in a gas reservoir can be calculated using Rᵥ. An exemplary formula for volume of gas is: Vc=(Area of Site×thickness×porosity×saturation of gas)×Rv/Bg.

Next, volume of oil can be converted to moles using MW_{O} and formulas known in the art. Similarly, volume of condensate can also be converted to moles using MW_{C} and formulas known in the art. The volume of gas can be converted to moles using formulas known in the art. Then the moles of oil or condensate and moles of gas can be added together to come up with total initial hydrocarbons. Once a total of initial hydrocarbons is known, the number of produced hydrocarbons can be found in the public domain and subtracted from the total initial hydrocarbons to determine remaining hydrocarbons.

Next, using a predetermined threshold, it can be determined whether a location of a well is adequate for production. If remaining hydrocarbons meets a predetermined threshold, then a related well location is appropriate. If, however, remaining hydrocarbons do not meet a predetermined threshold, then a related well location is not appropriate.

In addition to determining whether a location for a well is appropriate, PVT model can be used for many other purposes within the oil and gas industry. Within geophysics and petrophysics, reliable estimates of sub-surface fluid densities are required. In interpreting seismic attributes in geophysical analysis for a self-sourced reservoir, the areal changes in fluid densities can be significant even over short distances. In Petrophysical log interpretation, especially for acoustic logs such as sonic logs, reliable estimates of fluid densities are required across the play. In one embodiment, PVT model 306 can estimate changes in fluid densities across play 101 using MW_{O} 316, MW_{C} 317 and/or black oil table 321.

Reservoir engineering computations such as optimizing well fracturing spacing in a horizontal well, determining optimum well spacing and drawdown control to maximize recovery of liquid hydrocarbons require understanding of PVT behavior. Reservoir engineering flow and storage calculations require extensive use of PVT characteristics. As such, PVT model 306 can, using PVT outputs 305 determine optimal well-spacing and drawdown to maximize recovery of hydrocarbons.

Reservoir engineering flow equations are essentially derived from the diffusivity equation. In the definition of diffusivity, black oil properties form two out of the three factors (viscosity and compressibility, which is a function of Bo, Rs and Bg). In storage calculations, the produced fluid volumes measure volumes are surface conditions need to be translated to subsurface and vice versa to determine hydrocarbon reserves, project economics etc. Black oil properties are required for these calculations. As such, PVT model 306 can perform engineering flow equations and storage calculations using black oil table 321

In production engineering, for optimal design of surface facilities design to maximize profit, it is necessary to understand the volume and type of hydrocarbons that will be produced at the surface from the project or groups of wells. PVT behavior is a key element in gaining this understanding. To that end, in one embodiment, PVT model 306 can determine optimum design of surface facilities using PVT outputs 305.

Black oil properties are important in production engineering calculations to design separator conditions in order to separate the produced hydrocarbon well stream to maximize the volume of the more expensive phase (oil or gas) depending on the commodity prices. In one embodiment, PVT model 306 can use PVT outputs 305 such as black oil table 321 to design separator conditions.

Hydrocarbons are sold in terms of fluid volumes and at different points along the sale process and ownerships, the pressure and temperature conditions are different and hence the volumes change. Understanding of shrinkage (1/Bo) is therefore essential for the volume accounting of hydrocarbons along the production and value chain. As such, in one embodiment, PVT model 306 can, using PVT outputs 305 perform volume accounting of hydrocarbons along a production value chain.

Lastly, for designing pumps, black oil properties are required for determining the capacity and the depth at which the pumps need to be installed. In one embodiment, PVT model 306 can calculate capacity and/or depth at which a pump should be installed.

It is understood that there can be other applications that are stored in memory 202 and are executable by processor 201 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in memory 202 and can be executable by processor 201. In this respect, the term “executable” means a program file that is in a form that can ultimately be run by processor 201. Examples of executable programs can be, for example, a compiled program that can be translated into machine code in a format that can be loaded into a random access portion of memory 202 and run by processor 201, source code that can be expressed in proper format such as object code that is capable of being loaded into a random access portion of memory 202 and executed by processor 201, or source code that can be interpreted by another executable program to generate instructions in a random access portion of memory 202 to be executed by processor 201, etc. An executable program can be stored in any portion or component of memory 202 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory 202 is defined herein as including both volatile and nonvolatile memory and data storage components. Volatile components are those that do not retain data values upon loss of power. Nonvolatile components are those that retain data upon a loss of power. Thus, memory 202 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random-access memory (SRAM), dynamic random-access memory (DRAM), or magnetic random-access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, processor 201 can represent multiple processors 201 and memory 202 can represent multiple memories that operate in parallel processing circuits, respectively. In such a case, local interface 203 can be an appropriate network, including a network that facilitates communication between any two of the multiple processor 201S, between any processors 201 and any of the memories, or between any two of the memories, etc. Local interface 203 can comprise additional systems designed to coordinate this communication, including, for example, performing load balancing. processor 201 can be of electrical or of some other available construction.

Although application 205, and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 4, 5, 6A, 7, and 14 show the functionality and operation of an implementation of portions of application 205. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as processor 201 in a computer system or other system. The machine code can be converted from the source code, etc. If embodied in hardware, each block can represent a circuit or a number of interconnected circuits to implement the specified logical function(s).

Although the flowcharts of FIGS. 4, 5, 6A, 7, and 14 show a specific order of execution, it is understood that the order of execution can differ from that which is depicted. For example, the order of execution of two or more blocks can be scrambled relative to the order shown. Also, two or more blocks shown in succession in FIGS. 4, 5, 6A, 7, and 14 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including application 205, that comprises software or code can be embodied in any computer-readable storage medium for use by or in connection with an instruction execution system such as, for example, processor 201 in a computer system or other system. In this sense, the logic can comprise, for example, statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media such as, for example, electronic, magnetic, optical, electromagnetic, infrared, or semiconductor media. More specific examples of a suitable computer-readable storage medium would include, but are not limited to, magnetic tapes, magnetic floppy diskettes, magnetic hard drives, memory cards, solid-state drives, USB flash drives, or optical discs. Also, the computer-readable storage medium can be a random-access memory (RAM) including, for example, static random-access memory (SRAM) and dynamic random-access memory (DRAM), or magnetic random-access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for generating a PVT model capable of predicting well behavior across a play comprising
obtaining, relating to each well of a subset of wells,
a measured API gravity; and
a measured gas-to-oil ratio (GOR); and
one or more lab experiments, said lab experiments measuring one or more PVT characteristics;
training a PVT model to match said measured API gravities and said measured GOR with said PVT characteristics;
inputting a PVT input into said PVT model, said PVT input related to an additional hydrocarbon sample, said PVT input comprising an API gravity and a GOR; and
receiving a PVT output from said PVT model, said PVT output based on said API gravity and said GOR.

2. The method of claim 1 wherein said PVT output comprises a composition table, said composition table calculated based on said API gravity and said GOR.

3. The method of claim 1 wherein said PVT output comprises a black oil table, said black oil table calculated based on said API gravity and said GOR.

4. The method of claim 1 wherein said PVT output comprises a molecular weight of oil, said molecular weight of oil calculated based on said API gravity and said GOR.

5. The method of claim 1 wherein said PVT output comprises a molecular weight of oil condensate, said molecular weight of oil condensate calculated based on said API gravity and said GOR.

6. The method of claim 1 wherein said PVT output comprises a saturation pressure, said saturation pressure calculated based on said API gravity and said GOR.

7. The method of claim 1 further comprising the step of determining a location of a well based at least in part by said PVT output.

8. A system for generating a PVT model capable of predicting well behavior across a play comprising
a memory comprising
an application; and
a data store; and
a processor that according to said application in said memory
obtains, relating to each well of a subset of wells,
a measured API gravity; and
a measured gas-to-oil ratio (GOR); and
one or more lab experiments, said lab experiments measuring one or more PVT characteristics;
trains a PVT model to match said measured API gravities and said measured GOR with said PVT characteristics;
inputs a PVT input into said PVT model, said PVT input related to an additional hydrocarbon sample, said PVT input comprising an API gravity and a GOR; and
receives a PVT output from said PVT model, said PVT output based on said API gravity and said GOR.

9. The system of claim 8 wherein obtaining said measured API gravities, said measured GORs, and said one or more lab experiments comprises obtaining sets of lab measurements from hydrocarbon samples from said subset of wells, each said set of lab measurements comprising said measured API gravity, said measured GOR, and said one or more lab experiments.

10. The system of claim 8 further wherein said processor, according to said application in said memory obtains, relating to each well of said subset of wells, a measured composition, further wherein said PVT model comprises a composition model, further wherein said PVT output comprises a composition table.

11. A method for generating a PVT model capable of predicting well behavior across a play comprising
obtaining sets of lab measurements from hydrocarbon samples of a subset of a plurality of wells, each set of said sets associated with a subset well of said subset of said plurality of wells, said lab measurements comprising
a measured API gravity;
a measured gas-to-oil (GOR) ratio;
a measured composition; and
one or more lab experiments;
training a model using said lab measurements by
tuning an equation of state by
dividing each of said measured compositions into component groupings, one or more groups of said component groupings comprising variable attributes; and
adjusting said variable attributes to match said one or more lab experiments;
adjusting Peneloux correction factors such that said measured API gravities and said measured GORs of said lab measurements match calculated API gravities and calculated GORs; and
creating a composition model, said composition model a function of a variable API gravity and a variable GOR, further said composition model a composition model constituent of a PVT model such that when said PVT model receive a PVT input comprising an API gravity and a GOR, said PVT model generates PVT output, said PVT output comprising a composition table generated using said composition model.

12. The method of claim 11 further comprising the step of feeding initial PVT inputs from remaining wells of said plurality of wells into said model that has been trained to produce an initial PVT output for each of said initial PVT inputs, each said initial PVT input comprising an initial API gravity and an initial GOR, each of said initial PVT outputs calculated using said initial API gravity and said initial GOR.

13. The method of claim 12 wherein each of said initial PVT outputs comprises an initial saturation pressure (P_{SAT}) calculated using said initial API gravity and said initial GOR.

14. The method of claim 13 further comprising the step of curve-fitting said initial P_{SAT}s to produce a P_{SAT} equation that calculates a subsequent P_{SAT} as a function of said variable API gravity and said variable GOR, said P_{SAT} equation a P_{SAT} constituent of said PVT model.

15. The method of claim 12 wherein each of said initial PVT outputs comprises an initial molecular weight of oil (MW_{O}) calculated using said initial API gravity and said initial GOR.

16. The method of claim 15 further comprising the step of curve-fitting said initial MW_{O}s to produce an MW_{O} equation that calculates a subsequent MW_{O} as a function of said variable API gravity and said variable GOR, said MW_{O} equation an MW_{O} constituent of said PVT model.

17. The method of claim 12 wherein each of said initial PVT outputs comprises an initial molecular weight of oil condensate (MW_{C}) calculated using said initial API gravity and said initial GOR.

18. The method of claim 17 further comprising the step of curve-fitting said initial MW_{C}s to produce an MW_{C} equation that calculates a subsequent MW_{C} as a function of said variable API gravity and said variable GOR, said MW_{C} equation an MW_{C} constituent of said PVT model.

19. The method of claim 12 wherein each of said initial PVT outputs comprises an initial black oil table calculated using said initial API gravity and said initial GOR.

20. The method of claim 17 further comprising the step of curve-fitting said initial black oil tables to produce a black oil table model that calculates a subsequent black oil table as a function of said variable API gravity and said variable GOR, said black oil table model a black oil table constituent of said PVT model.

21. The method of claim 18 further comprising the steps of
determining remaining hydrocarbons for a site using said subsequent black oil table generated from a subsequent PVT input; and
choosing a new well location of a new well based at least in part on said determination.

22. The method of claim 12 wherein each of said initial PVT outputs comprises a characteristic line calculated using said initial API gravity and said initial GOR.

23. The method of claim 22 further comprising the step of determining a saturation limit line based on said characteristic lines.

24. The method of claim 23 further comprising the step of plotting said saturation limit line on an API gravity-GOR graph, said saturation limit line forming at least a portion of a characteristic plot, said characteristic plot a characteristic plot constituent of said PVT model.

25. The method of claim 23 further comprising the steps:
feeding a subsequent PVT input related to a new hydrocarbon sample into said PVT model;
generating a subsequent characteristic point related to said subsequent PVT input; and
determining if said hydrocarbon sample is saturated if said subsequent characteristic point is below said saturation limit line.

26. The method of claim 22 further comprising the step of determining a sample validity limit line based on said characteristic lines.

27. The method of claim 26 further comprising the step of plotting said sample validity limit line on said API gravity-GOR graph, said sample validity limit line forming at least a portion of a characteristic plot, said characteristic plot a characteristic plot constituent of said PVT model.

28. The method of claim 26 further comprising the steps:
feeding a subsequent PVT input related to a new hydrocarbon sample into said PVT model;
generating a subsequent characteristic point related to said subsequent PVT input; and
screening out said hydrocarbon sample if said subsequent characteristic point is above said sample validity limit line.

29. A system for generating a PVT model capable of predicting well behavior across a play comprising
a memory comprising
an application; and
a data store; and
a processor that according to said application in said memory
obtains sets of lab measurements from hydrocarbon samples of a subset of a plurality of wells, each set of said sets associated with a subset well of said subset of said plurality of well, said lab measurements comprising
a measured API gravity;
a measured gas-to-oil (GOR) ratio;
a measured composition; and
one or more lab experiments; and
trains a model using said lab measurements by
tuning an equation of state by
dividing each of said measured compositions into component groupings, one or more groups of said component groupings comprising variable attributes; and
adjusting said variable attributes to match said one or more lab experiments;
adjusting Peneloux correction factors such that said measured API gravities and said measured GORs of said lab measurements match calculated API gravities and calculated GORs; and
creating a composition model, said composition model a function of a variable API gravity and a variable GOR, further said composition model a composition model constituent of a PVT model such that when said PVT model receives a PVT input comprising an API gravity and a GOR, said PVT model generates a PVT output, said PVT output comprising a composition table generated using said composition model.

30. The system of claim 29 wherein said hydrocarbon sample is an oil hydrocarbon sample.

31. The system of claim 29 wherein said hydrocarbon sample is a gas condensate hydrocarbon sample.

32. The system of claim 29 wherein said one or more lab experiments comprises a constant composition expansion test.

33. The system of claim 29 wherein said one or more lab experiments comprises a constant volume depletion test.

34. The system of claim 29 wherein said one or more lab experiments comprises a differential liberator test.

35. The system of claim 29 wherein said one or more lab experiments comprises a separator test.

36. The system of claim 29 further wherein said processor feeds sets of initial PVT inputs from remaining wells of said plurality of wells into said model that has been trained to produce initial PVT outputs.

37. The system of claim 36 further wherein said processor curve-fits said initial PVT outputs to produce one or more functions of a variable API and a variable GOR, said one or more functions a constituent of said PVT model.

38. The system of claim 36 further wherein the processor determines a location of a well at least in part by
feeding a subsequent PVT input into said PVT model, said subsequent PVT input comprising a subsequent API gravity and a subsequent GOR,
receiving a subsequent PVT output from said PVT model, and
basing said determination on said subsequent PVT output.

39. The system of claim 36 wherein said one or more functions comprises a P_{SAT} equation and said subsequent PVT output comprises a subsequent P_{SAT}.

40. The system of claim 36 wherein said one or more functions comprises an MW_{O} equation and said subsequent PVT output comprises a subsequent MW_{O}.

41. The system of claim 36 wherein said one or more functions comprises an MW_{C} equation and said subsequent PVT output comprises a subsequent MW_{C}.

42. The system of claim 36 wherein said one or more functions comprises a black oil table model and said subsequent PVT output comprises a subsequent black oil table.

43. The system of claim 36 wherein said PVT input further comprises an N₂.

44. The system of claim 29 wherein said PVT input further comprises an H₂S.

45. The system of claim 29 wherein said PVT input further comprises a CO₂.

46. A computer readable storage medium having a computer readable program code embodied therein, wherein the computer readable program code is adapted to be executed to implement the method of claim 1.
